(19) United States
(12) Patent Application Publication
(10) Pub. No.: US 2020/0209876 A1
(43) Pub. Date: Jul. 2, 2020

(54) POSITIONING METHOD AND APPARATUS WITH THE SAME

(71) Applicant: UBTECH ROBOTICS CORP LTD., Shenzhen (CN)

(72) Inventors: Yongsheng Zhao, Shenzhen (CN); Youjun Xiong, Shenzhen (CN); Longbiao Bai, Shenzhen (CN); Jianxin Pang, Shenzhen (CN)

(21) Appl. No.: 16/396,783

(22) Filed: Apr. 29, 2019

(30) Foreign Application Priority Data
Dec. 29, 2018 (CN) 201811639043.9

(51) Int. Cl. G05D 1/02; B25J 9/00; B25J 9/16

(52) U.S. Cl. CPC G05D 1/0221; G05D 1/0229; B25J 9/1664; B25J 9/1684; B25J 9/0003

(57) ABSTRACT

The present disclosure provides a positioning method and an apparatus with the same. The method includes: obtaining, by die sensor set, current track node information of a current track node of a map on which the to-be-positioned device is located, where the current track node information includes a color of the current track node; and determining position information of the to-be-positioned device based on the track node information. In the above manner, the positioning of the to-be-positioned device in a specific map can be realized.

### CROSS REFERENCE TO RELATED APPLICATIONS

This application claims priority to Chinese Patent Application No. 201811639043.9, tiled Dec. 29, 2018, which is hereby incorporated by reference herein as if set forth in its entirety.

### BACKGROUND

### 1. Technical Field

The present disclosure relates to positioning and navigation technologies, and particularly to a positioning method and an apparatus with the same.

### 2. Description of Related Art

With the development of science and technology, the technologies of artificial intelligence, machine learning, and Internet of Things (IoT) are developed continuously, various robots have been applied to all aspects of people's life.

For example, micro-robots and toy robots such as toy cars that are moved on a map with a specific pattern (i.e., a desktop map). Both of the two types of robot are equipped with the devices for mobile communication and data collection, so as to be moved on the map.

However, in the prior art, a micro-robot or toy robot on the map generally does not know the coordinate of its position, and does not know how to reach another target position from one target position, that is, the micro-robot or toy robot in the prior art is not possible to realize the positioning of itself.

### BRIEF DESCRIPTION OF THE DRAWINGS

To describe the technical schemes in this embodiments of the present disclosure more clearly, the following briefly introduces the drawings required for describing the embodiments or the prior art. Apparently, the drawings in the following description merely show some examples of the present disclosure. For those skilled in the art, other drawings can be obtained according to the drawings without creative efforts.

FIG. 1 is a flow chart of a first embodiment of a positioning method according to the present disclosure.

FIG. 2 is a schematic diagram of a portion of a desktop map according to an embodiment of the present disclosure.

FIG. 3 is a schematic block diagram of a sensor set according to an embodiment of the present disclosure,

FIG. 4 is a flow, chart of an embodiment of step S400 of the first embodiment of the positioning method in FIG. 1.

FIG. 5 is a flow chart of an embodiment of step S430 of the first embodiment of the positioning method in FIG. 1.

FIG. 6 is a flow chart of a second embodiment of a positioning method according to the present disclosure.

FIG. 7 is a schematic block diagram of a positioning apparatus according to an embodiment of the present disclosure.

FIG. 8 is a schematic block diagram of a non-transitory computer readable storage medium according to an embodiment of the present disclosure.

### DETAILED DESCRIPTION

The technical solutions in the embodiments of the present disclosure will be dearly and completely described below in conjunction with the drawings in the embodiments of the present disclosure. Apparently, the following embodiments are only part of the embodiments of the present disclosure, not al l of the embodiments of the present disclosure. All other embodiments obtained by those skilled in the art without creative efforts are within the scope of the present disclosure.

In the present application, the terms “first”, “second”, and “third” are for descriptive purposes only, and are not to be comprehended as indicating or implying the relative importance or implicitly indicating the amount of technical features indicated. Thus, the feature limited by “first”, “second”, and “third” may include at least one of the feature either explicitly or implicitly. In the description of the present application, the meaning of “a plurality” is at least two, for example, two, three, and the like, unless specifically defined otherwise.

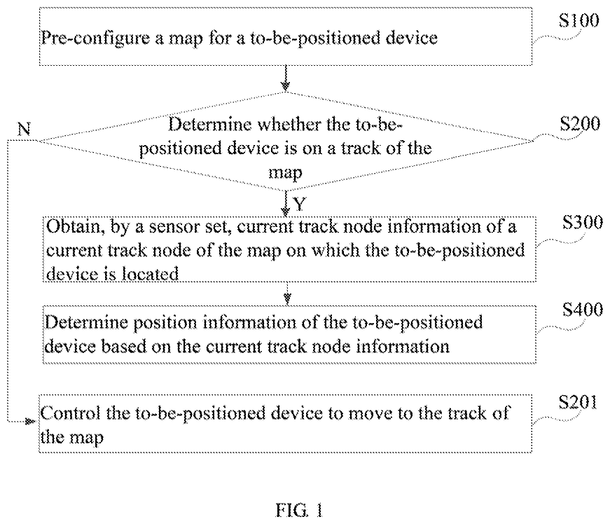

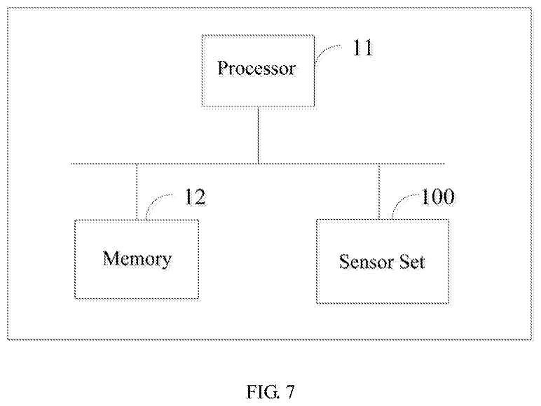

FIG. 1 is a flow chart of a first embodiment of a positioning method according to the present disclosure. In this embodiment, a positioning method is provided. The method is a computer-implemented method executable for a processor, which may be implemented through and applied to a positioning apparatus as shown in FIG. 7, that is, a to-be-positioned device, or through a storage medium.

As shown in FIG. 1, in this embodiment, the method includes the follow big steps.

S100: pre-configuring a map for the to-be-positioned device.

In this embodiment, the to-be-positioned device may be a device that can be moved on a desktop map which may be, but is not limited, to a robot, a toy vehicle, and the like, and the to-be-positioned device is provided with a sensor set at a bottom portion of the to-be-positioned device.

The desktop map for the to-be-positioned device needs to be configured in advance, which includes configuring the width and the color of tracks on the map to facilitate the sensor set on the to-be-positioned device to identify the tracks.

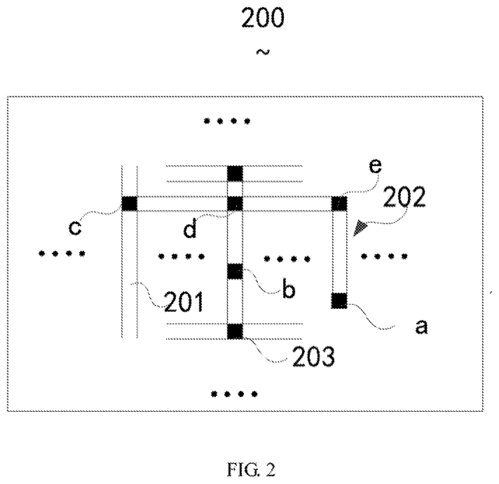

FIG. 2 is a schematic diagram of a portion of a desktop map according to an embodiment of the present disclosure. As shown in FIG. 2, in this embodiment, a desktop map 200 is provided, which includes a plurality of tracks 201 and protection areas 202 each disposed around each track 201, where the plurality of tracks 201 are disposed perpendicularly intersect to each other to form track nodes 203. The color of the tracks 201 and the protection areas 202 of the desktop map 200 needs to be sufficiently large in gray scale. In one embodiment, the color of the tracks 201 may be set to a dark color such as black, blue, purple, and the like, and the color of the protection areas 202 may he set to a light color such as white, yellow, pink, and the like. In other embodiments, the color of the tracks 201 may be set to a light color, and the color of the protection area 202 may be set to a dark color, which is not limited herein.

Furthermore, the track node 203 as, an intersection of the tracks 201, which needs to have a color different from the color of the tracks 201 and the protection areas 202. In addition, when setting the color, the colors at other portions on the map 200 may not use the colors of the tracks 201 and the track nodes 203 so as to prevent the to-be-positioned device from being affected when moving on the map 200. The colors of tracks 201 and track nodes 203 have to be easily identified and distinguished by the sensor set on the to-be-positioned device. For example, assuming that the color that the sensor set can accurately identify can be divided into N types, the color of the track nodes 203 can be N-2 types.

Further referring to FIG. 2, in this embodiment, there are five types of track nodes:

endpoint type nodes such as track node ‘a’ of FIG. 2; straight line type nodes such as track node ‘b’ of FIG. 2; T type nodes such as track node ‘c’ of FIG. 2; X type nodes such as track node ‘d’ of FIG. 2; and corner type nodes such as track node ‘e’ of FIG. 2.

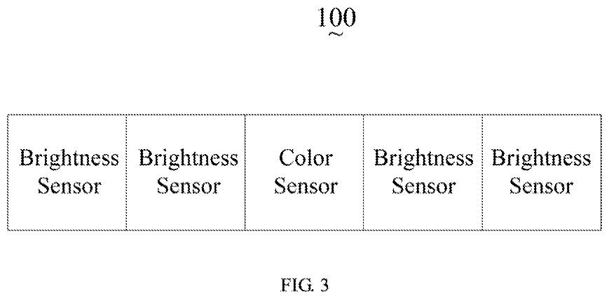

After the desktop map is configured, the desktop map can be used to position and navigate the positioning device. FIG. 3 is a schematic block diagram of a sensor set according to an embodiment of the present disclosure. As shown in FIG. 3, in this embodiment, a sensor set 100 is provided, which is installed on the to-be-positioned device for identifying the colors on the above-mentioned desktop map. For instance, five probes are disposed on the sensor set 100, where the probe on a middle portion of the sensor set 100 is a color sensor for detecting the color of the tracks 201 in the desktop map 200, and the probes on both sides of the sensor set 100 are brightness sensors for detecting the brightness of the protection areas 202 in the desktop map 200. In other embodiments, all the five probes can be color sensors.

In an application scenario, assume that the color of the tracks 201 in the desktop map 200 is a dark color (e.g., purple), the color of the protection areas 202 on both sides of the tracks 201 is a light color (e.g., white), the color of the track nodes 203 can be set to any color other than purple and white. In addition, the color of the track nodes 203 in the desktop map 200 can be set to a same color, that is, any color other than the above-mentioned purple and white.

In other embodiments, the color of the track nodes 203 in the desktop map 200 can also be different. In the case that the types of colors is sufficient for use, by using different colors on each track node 203, the sensor set 100 can achieve the positioning of the to-be-positioned device at the same time of identified the color of the track nodes 203, that is, the sensor set 100 in the to-be-positioned device can directly position the to-be-positioned device according to the color of the identified track nodes 203, without using a path shape (which depends on the tracks connected to the identified track node 203), the position, and other information of the track nodes 203 for auxiliary determination.

For instance, when the to-be-positioned device is moved along the track 201, the color sensor in the middle portion of the sensor set 100 will detect that the color of the tracks 201 is a dark color, and the brightness sensors on both sides of the sensor set 100 will detect that the color of the protection area 202 is a light color. Furthermore, when passing through the perpendicularly intersected track nodes 203, if there is a track 201 on the left or right side of the track node 203 in the movement direction, the brightness sensors on both sides will detect that the color of the track 201 is dark.

In addition, in this embodiment, the to-be-positioned device can identify whether there is a track 201 in front of the track node 203 (i.e., in the movement direction) by using the following two methods:

1. continuing to move the to-be-positioned device along the movement direction, so that the probe in the middle of the sensor set 100 can detect that there is a dark colored track 201 or a light colored protection area 202 in the movement direction. In which, if it is detected that there is a dark color in the movement direction, it indicates that there is a track 201 in front of the track node 203; and if it is detected that there is a light color in the movement direction, it indicates that there is no track 201 in front of the track node 203.

2. making the sensor set 100 of the to-be-positioned device to be located above the track node 203, and then controlling the to-be-positioned device to rotate in its original place for a predetermined angle clockwise or counterclockwise, where the predetermined angle may be greater than or equal to 90 degrees. As such, the probes on both sides of the sensor set 100 (i.e., brightness sensors) can detect whether there is a track 201 in front of the track node 203. For example, if the rotated brightness sensors detects that there is a dark color in from of the track node 203, it indicates that there is a track 201; otherwise, if they detects that there is a light color in front of the track node 203, it indicates that there is no track 201.

In this embodiment, the color of die track 201 in the desktop map 200 is dark by default, the color of the protection area 202 is light by default, and all the colors of the track nodes 203 are different by default. In other embodiments, the colors of the track 201, the protection area 202, and the track node 203 in the desktop map 200 can use other coloring schemes, which is not limited herein.

In this embodiment, after the desktop map 200 for the to-be-positioned device is pre-configured in step S100, the positioning (and the navigation) of the to-be-positioned device may be implemented based on the map 200.

In this embodiment, when placing the to-be-positioned device on the map 200, its current position is positioned, and then the navigation may be performed after the positioning is completed.

S200: determining whether the to-be-positioned device is on the track of the map.

In this embodiment, after configuring the map 200 for the to-be-positioned device, the to-be-positioned device is placed on the map 200. Therefore, it needs to determine the current state of the to-be-positioned device, that is, to determine whether the to-be-positioned device is on the track 201 of the map 200. The determination of the current, state of the to-be-positioned device can be implemented by using the sensor set 100 of the to-be-positioned device.

In this embodiment, the to-be-positioned device is controlled to move randomly on the map 200. If the color identified by the sensor set 100 is light, it indicates that the to-be-positioned device is not currently on the track 201 of the map 200, and step S201 can be executed; otherwise, it indicates that the to-be-positioned device is on the track 201 of the map 200, and step S300 is executed.

S201: controlling the to-be-positioned device to move to the track of the map.

If it is determined that the to-be-positioned device is not on the track 201 of the map 200, it needs to control the to-be-positioned device to enter the track 201 of the map 200. In this embodiment, the to-be-positioned device may be controlled to randomly move on the desktop map 200 or turn circles in its original place until the sensor set 100 of the to-be-positioned device detects a dark color (i.e., the color of the track 201), and then automatically begin to move along the dark-colored track 201.

S300: obtaining, by the sensor set, current track node information of a current track node of a map on which the to-be-positioned device is located, where the current track node information includes a color and the path shape of the current track node.

In this embodiment, if it is determined that the to-be-positioned device is located on the track 201 of the map 200, the track node information of the track node 203 in the movement direction of the to-be-positioned device may be obtained. For instance, if the sensor set 100 has detected a color different from the track 201 in the movement direction of the to-be-positioned device, it indicates that the to-be-positioned device has reached a position of the track node 203, that is, the current track node 203. At this time, the track node information of the track node 203 is further obtained, where the track node information includes the color of the track node 203. In other embodiments, may include at least one or a combination of the color, the path shape, and the position of the track node 203 as well as the rotation direction of the to-be-positioned device at a last track node 203 (i.e., the track node 203 which the to-be-positioned device passed before the current track node 203).

S400: determining position information of the to-be-positioned device based on the current track node information.

In this embodiment, the position information includes a position or a pose of the robot on the map 200, where the position corresponds to a coordinate system, and the pose includes a position and a posture.

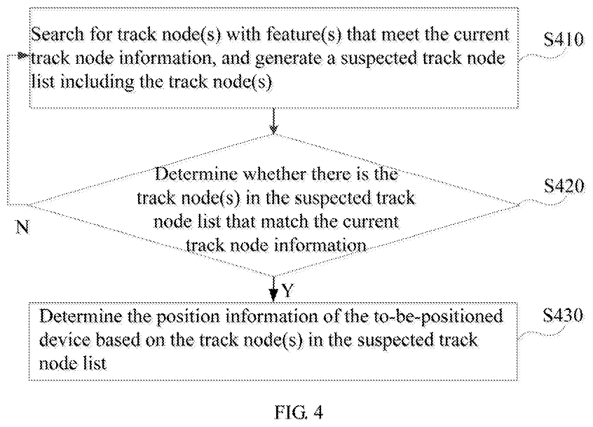

FIG. 4 is a flow chart of an embodiment of step S400 of the first embodiment of the positioning method in FIG. 1. As shown in FIG. 4, step S400 includes the following steps.

S410: searching for track node(s) with feature(s) that meet the current track node information, and generating a suspected track node list including the track node(s).

In this embodiment, the track node(s) 203 with the feature(s) (e.g., a color, a path shape, and/or a position) that meet the current track node information is searched in a pre-stored desktop map information database, and the suspected track node list which includes the track node(s) 203 with the met feature(s) is generated.

S420: determining whether there is the track node(s) in the suspected track node list that match the current track node information.

If the track node(s) in the suspected track node list that match the current track node information do not exist, it indicates that the positioning of the to-be-positioned device which performed when entering the track 201 fails, and the suspected track node list is cleared and step S410 is executed; otherwise, step S430 is executed.

S430: determining the position information of the to-be-positioned device based on the track node(s) in the suspected track node list.

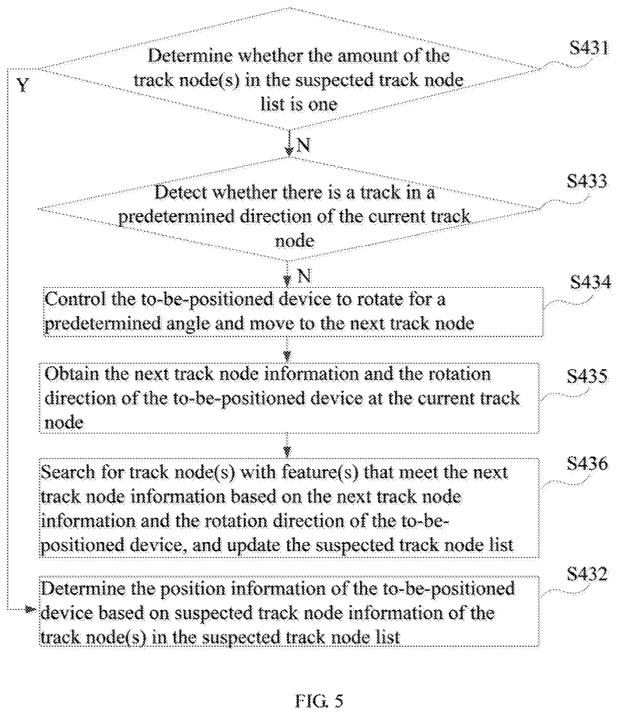

FIG. 5 is a flow chart of an embodiment of step S430 of the first embodiment of the positioning method in FIG. 1. As shown in FIG. 5, step S400 includes the following sub-steps.

S431: determining whether the amount of the track node(s) in the suspected track node list is one.

In this embodiment, if it is determined that the amount of the track nodes 203 in the suspected track node list is one, it indicates that the to-be-positioned device has determined its position and direction on the desktop map 200, and step S432 is executed; otherwise, if it is determined that the amount of the track nodes 203 in the suspected track node list is not 1, it indicates that there are multiple track nodes 203 that match the current track node 203, and step S435 is executed.

S432: determining the position information of the to-be-positioned device based on suspected track node information of the track node(s) in the suspected track node list.

In this embodiment, since the to-be-positioned device has determined its position and direction on the desktop map 200, the position information of the to-be-positioned device is determined directly based on the suspected track node information of the track node(s) 203 in the suspected track node list, and ends its track-entering state to wait for subsequent positioning, navigation, or other instructions.

S433: detecting whether there is a track in a predetermined direction of the current track node.

In this embodiment, if it is determined that the amount of the track nodes 203 in the suspected track node list is plural (i.e., more than one), it is necessary to detect whether there is a track in the predetermined direction of the current track node 203. The to-be-positioned device is controlled to move according to the path shape of the identified current track node 203 (the path shape depends on the tracks connected to the identified current track node 203 along the predetermined direction (which may be the front, the left, or the right direction of the current position of the to-be-positioned device). If the sensor set 100 on the to-be-positioned device detects that there is no track in the predetermined direction, step S434 is executed; otherwise, if the sensor set 100 detects that there is a track in the predetermined direction, the to-be-positioned device is controlled to rotate to the predetermined direction and to move to the next track node.

S434: controlling the to-be-positioned device to rotate for a predetermined angle, and move to the next track node.

In this embodiment, if it is determined that there is no track in the predetermined direction attic current track node 203 of the to-be-positioned device, the to-be-positioned device is controlled to rotate for the predetermined angle (e.g., rotated clockwise or counterclockwise by 180° in the current movement direction), and continues to move until the to-be-positioned device encounters another track node 203, that is, the next track node 203 again.

S435: obtaining next track node information of a next track node and a rotation direction of the to-be-positioned device at the current track node.

The sensor set 100 on the to-be-positioned device detects and records one or more of the color, the path shape of the track node 203, and obtains the rotation direction of the to-be-positioned device at a last track node 203 (i.e., the track node 203 which the to-be-positioned device passed before the current track node 203).

S436: searching for one or more track nodes with feature(s) that meet the next track node information based on the next track node information and the rotation direction of the to-be-positioned device, and updating the suspected track node list.

In this embodiment, the track node(s) 203 in the suspected track node list which are recorded when the to-be-positioned device is at the current track node 203 is used as a starting point to search its adjacent track nodes 203 which have feature(s) that meet the next track node information, and the suspected track node list is updated by, for example, clearing the current suspected track node list and generating a new suspected track node list.

In this embodiment, after the generating the new suspected track node list, the processes after step S420 are executed (i.e., it goes back to step S420) to determine the position and the direction of the to-be-positioned device on the desktop map 200. In which, the subsequent positioning process is similar to the process in the above-mentioned embodiment, which is not described herein.

It can be understood that, in this embodiment, after the positioning of the to-be-positioned device which performed when entering the track 201 is successful, the to-be-positioned device can know the position of itself and can be moved along the planned track 201. The positioning during the process of movement is similar to the above-mentioned positioning which performed when entering the track 201, that is, after the to-be-positioned device teaches the current track node 203, the sensor set 100 detects the color and the path shape of the track node 203 and records them to a computing unit of the to-be-positioned device, and simultaneously obtains and records the rotation direction of the to-be-positioned device at the previous track node 203 (also referred to as the historical track node). Based on the position of the previous track node 203 and the orientation of the to-be-positioned device, and the movement direction of the to-be-positioned device, the track node 203 which matches the position, the color, and the path shape information of the current track node 203 is searched in the map information database. If it matches, it indicates that the positioning of the to-be-positioned device is correct, and the position and he direction of the to-be-positioned device are calculated; otherwise, if it does not match (that is, there is no track node in the map information database that matches the current track node information), it indicates that the to-be-positioned device is positioned incorrectly, and then re-enters the process of track-entering positioning, that is, the steps S200-S400 described above. For details, please refer to the description above.

It can be understood that, in this embodiment, step S100 and step S200 are no necessary steps to implement the positioning method, and those skilled in the art may modify or omit according to actual usage.

In this embodiment, by directly obtaining the feature information of the current track node of the map on which the to-be-positioned device is located, the position information of the to-be-positioned device is comprehensively determined based on the color, the path shape, and the position of the track, node, thereby realizing the autonomous positioning of the to-be-positioned device on the map.

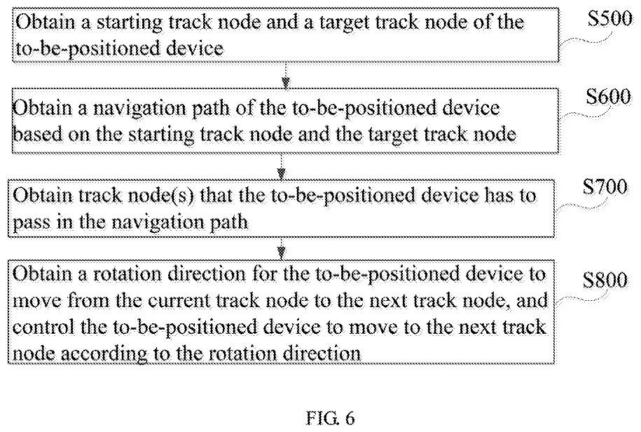

FIG. 6 is a flow chart of a second embodiment of a positioning method according to the present disclosure. In this embodiment, the positioning method further realizes the navigation of the to-be-positioned device based on the above-mentioned positioning method. As shown in FIG. 6, in this embodiment, the positioning method includes the following steps.

S500: obtaining a starting track node and a target track node of the to-be-positioned device.

S600: obtaining a navigation path of the to-be-positioned device based on the starting track node and the target track node.

It can be understood that, if the current position information of the to-be-positioned device, that is, the current position and direction of the to-be-positioned device, is not obtained before step S600, the above-mentioned steps of track-entering, positioning, and the like have to be re-executed on the to-be-positioned device.

In this embodiment, if the current position information of the to-be-positioned device is obtained, a path planning tot the to-be-positioned device may be performed based on the current position information. For example, the starting track node and the target track node of the to-be-positioned device are input in advance, and a computing unit (e.g., a processor) of the to-be-positioned device calculates based on the desktop map information to plan a shortest path.

S700: obtaining track node(s) that the to-be-positioned device has to pass in the navigation path.

In which, the track node(s) 203 in the path that the to-be-positioned device has to pass is recorded to a track node list.

S800: obtaining a rotation direction for the to-be-positioned device to move from the current track node to the next track node, and controlling the to-be-positioned device to move to the next track node according to the rotation direction.

Furthermore, when the to-be-positioned device is moved from the current track node 203 to the next track node 203, it needs to calculate its rotation direction, control the to-be-positioned device to rotate according to the rotation direction, move along the track 201 until the next track node 203 is encountered, and calculate the direction needed to rotate for moving to the next track node 203. In one embodiment, the track nodes 203 that the to-be-positioned device has passed can be directly deleted from the track node list until the track node list is empty which indicates that the to-be-positioned device has reached the target track node 203.

In this embodiment, by directly obtaining the feature information of the current track node of the map on which the to-be-positioned device is located, the position information of the to-be-positioned device is comprehensively determined based on the color, the path shape, and the position of the track node, thereby realizing the autonomous positioning of the to-be-positioned device on the map. In addition, if the target track node of the to-be-positioned device is provided, the to-be-positioned device can autonomously perform a path planning basal on the target track node to realize navigation on the map.

FIG. 7 is a schematic block diagram of a positioning apparatus according to an embodiment of the present disclosure. As shown in FIG. 7, in this embodiment, a positioning apparatus is provided. The apparatus includes a processor 11, and a memory 12, and a sensor set 100 which are coupled to the processor 11. In this embodiment, the positioning apparatus is a robot.

The memory 12 is configured to store a computer program which includes instructions for implementing any of the above-mentioned positioning methods. In one example, the computer program includes: instructions for obtaining, by the sensor set, current track node information of a current track node of a map on which the to-be-positioned device is located, wherein the current track node information includes a color of the current track node; and instructions for determining position information of the to-be-positioned device based on the current track node information. The apparatus is a to-be-positioned device. The sensor set 100 (see FIG. 3) is disposed at a bottom portion of the apparatus.

The processor 11 is configured to execute the instructions in the computer program stored in the memory 12.

In which, the processor 11 may also be known as a central processing unit (CPU). The processor 11 may be an integrated circuit chip with signal processing capability. The processor 11 may also be a general purpose processor, a digital signal processor (DSP), an application specific integrated circuit (ASIC), a field programmable gate array (FPGA), or be other programmable logic device, a discrete gate, a transistor logic device, and a discrete hardware component. The general purpose processor may be a microprocessor, or the processor 11 may also be any conventional processor.

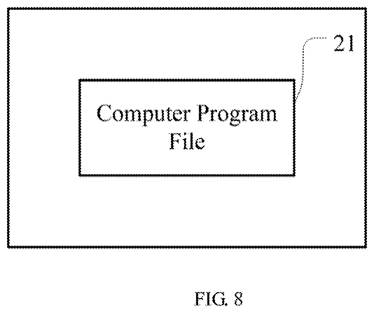

FIG. 8 is a schematic block diagram of a non-transitory computer readable storage medium according to an embodiment of the present disclosure. As shown in FIG. 8, in this embodiment, a non-transitory computer readable storage medium is provided, which is configured to store a computer program the 21 capable of implementing all of the above-mentioned methods, where the computer program file 21 may be stored in the above-mentioned storage medium in the form of a software product, which includes a number of instructions for enabling a computer device (which can be a personal computer, a server, a network device, etc.) or a processor to execute all or a part of the steps of the methods described in each of the embodiments of the present disclosure. The above-mentioned storage device includes a variety of media such as a USB disk, a mobile hard disk, a read-only memory (ROM), a random access memory (RAM), a magnetic disk, and an optical disk which is capable of storing program codes, or a terminal device such as a computer, a server, a mobile phone, or a tablet.

In the embodiments provided by the present disclosure, it should be understood that the disclosed apparatus and method may be implemented in other manners. For example, the above-mentioned apparatus embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

In addition, the functional units and/or modules in the embodiments may be integrated in one processing unit, or each unit may exist alone physically, or two or more units may be integrated in one unit. The above-mentioned integrated unit may be implemented in the thrill of hardware or in the form of software functional unit.

In summary, those skilled in the art can easily understand that, the present disclosure provides a positioning method and an apparatus with the same, and by directly obtaining the feature information of the current track node of the map on which the to-be-positioned device is located, the position information of the to-be-positioned device is comprehensively determined based on the color, the'path shape, and the position of the track node, thereby realizing the autonomous positioning of the to-be-positioned device on the map. In addition, if the target track node of the to-be-positioned device is provided, the to-be-positioned device can autonomously perform a path planning based on the target track node to realize navigation on the map.

The foregoing is merely embodiments of the present disclosure, and is not intended to limit the scope of the present disclosure. Any equivalent structure or flow transformation made based on the specification and the accompanying drawings of the present disclosure, or any direct or is direct applications of the present disclosure on other related fields, shall all be covered within the protection of the present disclosure.

What is claimed is:

1. A computer-implemented positioning method for a to-be-positioned device having a sensor set, the method comprising executing on a processor of the to-be-positioned device the steps of:
obtaining, by the sensor set, current track node information of a current track node of a map on which the to-be-positioned device is located, wherein the current track node information comprises a color of the current track node; and
determining position information of the to-he-positioned device based on the current track node information.

2. The method of claim 1, wherein the step of determining the position information of the to-be-positioned device based on the current track node information comprises;
searching for one or more track nodes with a feature meeting the current track node information, and generating a suspected track node list comprising the one or more track nodes;
determining whether there is the track node in the suspected track node list matching the current track node information; and
determining the position information of the to-be-positioned device based on the one or more track nodes in the suspected track node list, in response to there being the track node in the suspected track node list matching the current track node information.

3. The method of claim 2, wherein the step of determining the position information of the to-be-positioned device based on the one or more track nodes in the suspected track node list comprises:
determining whether the amount of the one or more track nodes in the suspected track node list is one;
determining the position information of the to-be-positioned device based on suspected track node information of the one or more track nodes in the suspected track node list, in response to determining the amount of the one or more track nodes in the suspected track node list being one;
obtaining next track node information of a next track node and a rotation direction of the to-be-positioned device at the current track node, in response to determining the amount of the one or more track nodes in the suspected track node list being not one; and
searching for one or more track nodes with a feature meeting the next track node information based on the next track node information and the rotation direction of the to-be-positioned device, and updating the suspected track node list.

4. The method of claim 3, wherein before the step of obtaining the next track node information of the next track node and the rotation direction of the to-be-positioned device at the current track node further comprises:
detecting whether there is a track in a predetermined direction of the current track node; and
controlling the to-be-positioned device to rotate for a predetermined angle and move to the next track node, in response to detecting there being no track in the predetermined direction of the current track node.

5. The method of claim 1, further comprising:
obtaining a starting track node and a target track node of the to-be-positioned device;
obtaining a navigation path of the to-be-positioned device based on the starting track node and the target track node;
moving the to-be-positioned device to the target track node according to the navigation path.

6. The method of claim 5, wherein the step of moving the to-be-positioned device to the target track node according to the navigation path comprises:
obtaining one or more track nodes that the to-be-positioned device has to pass in the navigation path; and
obtaining a rotation direction for the to-be-positioned device to move from the current track node to a next track node in the one or more track nodes, and controlling the to-be-positioned device to move to the next track node according to the rotation direction.

7. The method of claim 1, wherein before the step of obtaining the current track node information of the current track node of the to-be-positioned device further comprises:
determining whether the to-be-positioned device is on a track of the map;
performing the step of obtaining the current track node information of the current track node of the to-be-positioned device, in response to determining the to-be-positioned device being on the track of the map; and
controlling the to-be-positioned device to move to the track of the map, in response to determining the to-be-positioned device being not on the track of the map.

8. The method of claim 1, wherein before the step of obtaining the current track node information of the current track node of the to-be-positioned device further comprises:
pre-configuring the map for the to-be-positioned device;
wherein, the map at least comprises a plurality of tracks and a protection area disposed on two sides of each track; wherein, the plurality of tracks vertically intersect to form track nodes, and the track, the protection area, and the track nodes have different colors.

9. A positioning apparatus, comprising:
a sensor set;
a processor;
a memory coupled to the processor; and
one or more computer programs stored in the memory and executable on the processor, wherein the one or more computer programs comprise:
instructions for obtaining, by the sensor set, current track node information of a current track node of a map on which the to-be-positioned device is located, wherein the current track node information comprises a color of the current track node; and
instructions for determining position information of the to-be-positioned device based on the current track node information.

10. The apparatus of claim 9, wherein the instructions for determining the position information of the to-be-positioned device based on the current track node information comprise:
instructions for searching for one or more track nodes with a feature meeting the current track node information, and generating a suspected track node list comprising the one or more track nodes;
instructions for determining whether there is the track node in the suspected track node list matching the current track node information; and
instructions for determining the position information of the to-be-positioned device based on the one or more track nodes in the suspected track node list, in response to there being the track node in the suspected track node list matching the current track node information.

11. The apparatus of claim 10, wherein the instructions for determining the position information of the to-be-positioned device based on the one or more track nodes in the suspected track node fist comprise:
instructions for determining whether the and mutt of the one or more track nodes in the suspected track node list is one;
instructions for determining the position information of the to-be-positioned device based on suspected track node information of the one or more track nodes in the suspected track node list, in response to determining the amount of the one or more track nodes in the suspected track node list being one;
instructions for obtaining next track node information of a next track node and a rotation direction of the to-be-positioned device at the current track node, in response to determining the amount of the one or more track nodes in the suspected track node list being not one; and
instructions for searching for one or more track nodes with a feature meeting the next track node information based on the next track node information and the rotation direction of the to-be-positioned device, and updating the suspected track node list.

12. The apparatus of claim 11, wherein the one or more computer programs further comprise:
instructions for detecting whether there is a track its a predetermined direction of the current track node; and
instructions for controlling the to-be-positioned device to rotate for a predetermined angle and move to the next track node, in response to detecting there being no track in the predetermined direction of the current track node.

13. The apparatus of claim 9, the one or more computer programs further comprise:
instructions for obtaining a starting track node and a target track node of the to-be-positioned device; and
instructions for obtaining a navigation path of the to-be-positioned device based on the starting track node and the target track node.

14. The apparatus of claim 13, wherein the instructions for moving to the target track node according to the navigation path comprise:
instructions for obtaining one or more track nodes that the to-be-positioned device has to pass in the navigation path; and
instructions for obtaining a rotation direction for the to-be-positioned device to move from the current track node to the next track node, and controlling the to-be-positioned device to move to the next track node according to the rotation direction.

15. The apparatus of claim 9, wherein the one or more computer programs further comprise:
instructions for determining whether the to-be-positioned device is on a track of the map;
instructions for performing the step of obtaining the current track node information of the current track node of the to-be-positioned device, in response to determining the to-be-positioned device being on the track of the map; and
instructions for controlling the to-be-positioned device to move to the track of the map, in response to determining the to-be-positioned device being not on the track of the map.

16. The apparatus of claim 9, wherein the one or more computer programs further comprise:
instructions for pre-configuring the map for the to-be-positioned device;
wherein, the map at least comprises a plurality of tracks and a protection area disposed on two sides of each track; wherein, the plurality of tracks vertically intersect to form track nodes, and the track, the protection area, and the track nodes have different colors.
